(19) United States
(12) Patent Application Publication
(10) Pub. No.: US 2026/0170578 A1
(43) Pub. Date: Jun. 18, 2026

(54) SYSTEM AND METHOD FOR GENERATING DATA BY COMBINING LARGE LANGUAGE MODELS AND AUTOMATED PLANNERS

(71) Applicant: JPMorgan Chase Bank, N.A., New York, NY (US)

(72) Inventors: Tomas DE LA ROSA TURBIDES, Getafe (ES); Sriram GOPALAKRISHNAN, West New York, NJ (US); Alberto POZANCO, Madrid (ES); Zhen ZENG, Ypsilanti, MI (US); Daniel BORRAJO, Pozuelo de Alarcon (ES); Ricardo MELA, Hartsdale, NY (US); Jonathan LALIMA, Manalapan, NJ (US)

(73) Assignee: JPMorgan Chase Bank, N.A., New York, NY (US)

(21) Appl. No.: 18/984,019

(22) Filed: Dec. 17, 2024

(51) Int. Cl. G06Q 50/14; G06Q 10/1093

(52) U.S. Cl. CPC G06Q 50/14; G06Q 10/1097

(57) ABSTRACT

Various methods and processes, apparatuses/systems, and media for improving performance of a data planning system are disclosed. A processor establishes a communication link among the data planning system, a multimodal large language model, an automated planning device, and a plurality of internal or external systems via a communication interface; receives, by the data planning system, user inputs data provided by a user regarding a configurable pre-desired travel plan to a configurable pre-desired travel location; executes, in response to receiving the user inputs data by the data planning system, an information retrieval process and a planning process to output planning data corresponding to the configurable pre-desired travel plan and the configurable pre-desired travel location by integrating the multimodal large language model and the automated planning device within the data planning system via the communication interface; and monitors the output planning data to replan accordingly based on an unforeseen event.

### TECHNICAL FIELD

This disclosure generally relates to automated data processing, and, more particularly, to methods and apparatuses for implementing a platform, language, cloud, and database agnostic automated data processing and generation module configured to automatically generate plans data that satisfies constraints fully by combining large language models (LLMs) and automated planners.

### BACKGROUND

The developments described in this section are known to the inventors. However, unless otherwise indicated, it should not be assumed that any of the developments described in this section qualify as prior art merely by virtue of their inclusion in this section, or that these developments are known to a person of ordinary skill in the art.

Travel planning may prove to be a complex task that involves generating a sequence of actions related to visiting places subject to constraints and maximizing some user satisfaction criteria. For example, traditional approaches may rely on problem formulation in a given formal language, extracting relevant travel information from web sources, and use an adequate problem solver to generate a valid solution. For example, various algorithmic approaches have been proposed to find exact or approximate optimal itineraries given points of interest (POIs) and certain constraints. A common limitation of the aforementioned approach may be the need for manual formulation of the optimization or planning problem. More recent works use deep learning techniques for POIs and travel recommendations, lifting the requirement for manual formulation of the planning problem. However, these deep learning models do not account for optimality from a planning perspective.

Conventional LLMs may possess extensive travel domain knowledge and may provide high-level information such as points of interest and potential routes. However, these conventional LLMs are not developed to reason about coherent constraint satisfaction or solution quality. For example, conventional LLM based approaches in travel planning may directly output plans data from user requests using language. Although these conventional LLMs possess extensive travel domain knowledge and provide high-level information like points of interest and potential routes, these LLMs often generate plans data that lack coherence, fail to satisfy constraints fully, and do not guarantee the generation of high-quality solutions, thereby substantially deteriorating model performance.

Moreover, the aforementioned conventional processes primarily evaluated LLMs in classical planning domains such as blocksworld, which may not have had sufficient relevant data during the training stage of these LLMs. Therefore, it may prove to be crucial to benchmark how well a multimodal large language model may readily address the travel planning problem from both constraints and utility perspectives to improve model performance.

### SUMMARY

The present disclosure, through one or more of its various aspects, embodiments, and/or specific features or sub-components, provides, among other features, various systems, servers, devices, methods, media, programs, and platforms for implementing a platform, language, cloud, and database agnostic automated data processing and generation module configured to automatically generate plans data (i.e., travel plans data, but the disclosure is not limited thereto) that satisfies constraints fully by combining LLMs and automated planners, thereby substantially improving performance of the LLMs in outputting high quality plans data, but the disclosure is not limited thereto. For example, the automated data processing and generation module disclosed herein may be configured to automatically generate travel plans data by gathering and combining travel information from LLM and other sources, and then computing a valid travel itinerary using an automated planner that guarantees the solution coherence and quality. The execution of this itinerary may also be monitored by the automated data processing and generation module in order to generate high quality data that suggests opportunities and replan in the event the computed plan data may not be carried out in a real world scenario.

In some embodiments, a method for improving performance of a data planning system by utilizing one or more processors along with allocated memory is disclosed. The method may include: establishing a communication link among the data planning system, a multimodal large language model, an automated planning device, and a plurality of internal or external systems via a communication interface; receiving, by the data planning system, user inputs data provided by a user regarding a configurable pre-desired travel plan to a configurable pre-desired travel location; executing, in response to receiving the user inputs data by the data planning system, an information retrieval process and a planning process to output planning data corresponding to the configurable pre-desired travel plan and the configurable pre-desired travel location by integrating the multimodal large language model and the automated planning device within the data planning system via the communication interface; wherein the information retrieval process may include: executing a series of queries to the multimodal large language model and the plurality of internal or external systems, via corresponding application programming interface, that provide data corresponding to the configurable pre-desired location; generating, in response to executing the series of queries, a plurality of planning tasks data to be utilized by the planning process to output the planning data; wherein the planning process may include: executing a series of algorithmic sub-tasks that utilize the plurality of planning tasks data; and automatically outputting the planning data in response to executing the series of algorithmic sub-tasks, wherein each sub-task utilize information from prior plans to inform computation, thereby improving performance of the data planning system in outputting the planning data and displaying the planning data onto a user interface within the data planning system.

In some embodiments, in executing the series of queries to the multimodal large language model, the method may further include: (i) requesting for a set of candidate POIs for an input city or region corresponding to the configurable pre-desired travel location; (ii) for each provided POI in (i), querying for a score that indicates a general popularity of the POIs; and (iii) for each provided POI in (i), querying for a time a user is recommended to spend in an activity.

In some embodiments, in executing the series of queries to the plurality of internal or external systems, the method may further include: querying a map-service API to collect information data corresponding to the configurable pre-desired travel location to populate a travel-time graph; and collecting, for each pair of POIs among the set of candidate POIs, an estimated time to move from one place to another place within the travel-time graph.

In some embodiments, the method may further include: querying a place information service to obtain a schedule data with opening or closing hours for each POIs and an estimated cost per person.

In some embodiments, the method may further include: querying an internal or external database to collect travel recommendation preference data.

In some embodiments, the method may further include: querying an internal or an external data source for past solutions similar to plans corresponding to the configurable pre-desired travel plan.

In some embodiments, in executing the series of algorithmic sub-tasks, the method may further include: (i) executing a trip segregation sub-task that may include, for the set of candidate POIs, geographically clustering using a clustering algorithm that considers one cluster of POIs per each day in the trip; (ii) executing a task generation sub-task that may include, for each cluster of POIs and associated planning tasks data for each cluster of POIs retrieved by the information retrieval process, translating each piece of information into a state variable represented into a planning domain description language (PDDL); (iii) executing a task resolution sub-task that may include, outputting the planning data using the PDDL generated in (ii), as well as preferences and constraints defined by the user by utilizing the automated planning device and outputting a sequence of actions that maximizes the score for a given day; iv) executing a plan composition sub-task that may include, aggregating in a two-level solution that includes: a list of days, with a city and location for a recommended accommodation requested by the user; and a day plan for each day, that may include a suggested schedule for visiting the POIs, eating in restaurants, and moving from one place to another place, but the disclosure is not limited thereto; and v) executing a plan monitoring sub-task that may include monitoring execution of the planning data output from the data planning system and outputting a replan data in an event the planning data output from the data planning system may not be carried out in a real world scenario.

In some embodiments according to the method, a format of the planning data output from the data planning system may include one or more of the following: plain text, comma separated vectors, JavaScript Object Notation (JSON) objects file format, executable python code, etc., but the disclosure is not limited thereto.

In some embodiments according to the method, the user inputs data may include one or more of the following data: number of travelers; city, region, or country to visit; total budget; time span in days; and user preferences on food, places, flight, hotel, service provider, etc., but the disclosure is not limited thereto.

In some embodiments, a system for improving performance of a data planning system is disclosed. The system may include: a processor; and a memory operatively connected to the processor via a communication interface, the memory storing computer readable instructions, when executed, may cause the processor to: establish a communication link among the data planning system, a multimodal large language model, an automated planning device, and a plurality of internal or external systems via a communication interface; receive, by the data planning system, user inputs data provided by a user regarding a configurable pre-desired travel plan to a configurable pre-desired travel location; execute, in response to receiving the user inputs data by the data planning system, an information retrieval process and a planning process to output planning data corresponding to the configurable pre-desired travel plan and the configurable pre-desired travel location by integrating the multimodal large language model and the automated planning device within the data planning system via the communication interface; wherein in executing the information retrieval process, the processor may be further configured to: execute a series of queries to the multimodal large language model and the plurality of internal or external systems, via corresponding application programming interface, that may provide data corresponding to the configurable pre-desired location; generate, in response to executing the series of queries, a plurality of planning tasks data to be utilized by the planning process to output the planning data; wherein in executing the planning process, the processor may be further configured to: execute a series of algorithmic sub-tasks that utilize the plurality of planning tasks data; and automatically output the planning data in response to executing the series of algorithmic sub-tasks, wherein each sub-task utilize information from prior plans to inform computation, thereby improving performance of the data planning system in outputting the planning data and displaying the planning data onto a user interface within the data planning system.

In some embodiments, in executing the series of queries to the multimodal large language model, the processor may be further configured to: (i) request for a set of candidate POIs for an input city or region corresponding to the configurable pre-desired travel location; (ii) for each provided POI in (i), query for a score that indicates a general popularity of the POIs; and (iii) for each provided POI in (i), query for a time a user is recommended to spend in an activity.

In some embodiments, in executing the series of queries to the plurality of internal or external systems, the processor may be further configured to: query a map-service API to collect information data corresponding to the configurable pre-desired travel location to populate a travel-time graph; and collect, for each pair of POIs among the set of candidate POIs, an estimated time to move from one place to another place within the travel-time graph.

In some embodiments, the processor may be further configured to: query a place information service to obtain a schedule data with opening or closing hours for each POIs and an estimated cost per person.

In some embodiments, the processor may be further configured to: query an internal or external database to collect travel recommendation preference data.

In some embodiments, the processor may be further configured to: query an internal or an external data source for past solutions similar to plans corresponding to the configurable pre-desired travel plan.

In some embodiments, in executing the series of algorithmic sub-tasks, the processor may be further configured to: (i) execute a trip segregation sub-task that includes, for the set of candidate POIs, geographically clustering using a clustering algorithm that considers one cluster of POIs per each day in the trip; (ii) execute a task generation sub-task that includes, for each cluster of POIs and associated planning tasks data for each cluster of POIs retrieved by the information retrieval process, translating each piece of information into a state variable represented into a PDDL; (iii) execute a task resolution sub-task that includes, outputting the planning data using the PDDL generated in (ii), as well as preferences and constraints defined by the user by utilizing the automated planning device and outputting a sequence of actions that maximizes the score for a given day; iv) execute a plan composition sub-task that may include, aggregating in a two-level solution that may include: a list of days, with a city and location for a recommended accommodation requested by the user; and a day plan for each day, that may include a suggested schedule for visiting the POIs, eating in restaurants, and moving from one place to another place, but the disclosure is not limited thereto; and v) execute a plan monitoring sub-task that may include monitoring execution of the planning data output from the data planning system and output a replan data in an event the planning data output from the data planning system may not be carried out in a real world scenario.

In some embodiments according to the system, a format of the planning data output from the data planning system may include one or more of the following: plain text, comma separated vectors, JSON objects file format, executable python code, etc., but the disclosure is not limited thereto.

In some embodiments according to the system, the user inputs data may include one or more of the following data: number of travelers; city, region, or country to visit; total budget; time span in days; and user preferences on food, places, flight, hotel, service provider, etc., but the disclosure is not limited thereto.

In some embodiments, a non-transitory computer readable medium configured to store instructions for improving performance of a data planning system is disclosed. The instructions, when executed, may cause a processor to perform the following: establishing a communication link among the data planning system, a multimodal large language model, an automated planning device, and a plurality of internal or external systems via a communication interface; receiving, by the data planning system, user inputs data provided by a user regarding a configurable pre-desired travel plan to a configurable pre-desired travel location; executing, in response to receiving the user inputs data by the data planning system, an information retrieval process and a planning process to output planning data corresponding to the configurable pre-desired travel plan and the configurable pre-desired travel location by integrating the multimodal large language model and the automated planning device within the data planning system via the communication interface; wherein in executing the information retrieval process, the instructions, when executed, may cause the processor to further perform the following: executing a series of queries to the multimodal large language model and the plurality of internal or external systems, via corresponding application programming interface, that provide data corresponding to the configurable pre-desired location; generating, in response to executing the series of queries, a plurality of planning tasks data to be utilized by the planning process to output the planning data; wherein in executing the planning process, the instructions, when executed, may cause the processor to further perform the following: executing a series of algorithmic sub-tasks that utilize the plurality of planning tasks data; and automatically outputting the planning data in response to executing the series of algorithmic sub-tasks, wherein each sub-task utilize information from prior plans to inform computation, thereby improving performance of the data planning system in outputting the planning data and displaying the planning data onto a user interface within the data planning system.

In some embodiments, in executing the series of queries to the multimodal large language model, the instructions, when executed, may cause the processor to further perform the following: (i) requesting for a set of candidate POIs for an input city or region corresponding to the configurable pre-desired travel location; (ii) for each provided POI in (i), querying for a score that indicates a general popularity of the POIs; and (iii) for each provided POI in (i), querying for a time a user is recommended to spend in an activity.

In some embodiments, in executing the series of queries to the plurality of internal or external systems, the instructions, when executed, may cause the processor to further perform the following: querying a map-service API to collect information data corresponding to the configurable pre-desired travel location to populate a travel-time graph; and collecting, for each pair of POIs among the set of candidate POIs, an estimated time to move from one place to another place within the travel-time graph.

In some embodiments, the instructions, when executed, may cause the processor to further perform the following: querying a place information service to obtain a schedule data with opening or closing hours for each POIs and an estimated cost per person.

In some embodiments, the instructions, when executed, may cause the processor to further perform the following: querying an internal or external database to collect travel recommendation preference data.

In some embodiments, the instructions, when executed, may cause the processor to further perform the following: querying an internal or an external data source for past solutions similar to plans corresponding to the configurable pre-desired travel plan.

In some embodiments, in executing the series of algorithmic sub-tasks, the instructions, when executed, may cause the processor to further perform the following: (i) executing a trip segregation sub-task that may include, for the set of candidate POIs, geographically clustering using a clustering algorithm that considers one cluster of POIs per each day in the trip; (ii) executing a task generation sub-task that may include, for each cluster of POIs and associated planning tasks data for each cluster of POIs retrieved by the information retrieval process, translating each piece of information into a state variable represented into a PDDL; (iii) executing a task resolution sub-task that may include, outputting the planning data using the PDDL generated in (ii), as well as preferences and constraints defined by the user by utilizing the automated planning device and outputting a sequence of actions that maximizes the score for a given day; iv) executing a plan composition sub-task that may include, aggregating in a two-level solution that includes: a list of days, with a city and location for a recommended accommodation requested by the user; and a day plan for each day, that may include a suggested schedule for visiting the POIs, eating in restaurants, and moving from one place to another place, but the disclosure is not limited thereto; and v) executing a plan monitoring sub-task that may include monitoring execution of the planning data output from the data planning system and outputting a replan data in an event the planning data output from the data planning system may not be carried out in a real world scenario.

In some embodiments according to the non-transitory computer readable medium, a format of the planning data output from the data planning system may include one or more of the following: plain text, comma separated vectors, JSON objects file format, executable python code, etc., but the disclosure is not limited thereto.

In some embodiments according to the non-transitory computer readable medium, the user inputs data may include one or more of the following data: number of travelers; city, region, or country to visit; total budget; time span in days; and user preferences on food, places, flight, hotel, service provider, etc., but the disclosure is not limited thereto.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates a computer system for implementing a platform, language, database, and cloud agnostic automated data processing and generation module configured to automatically generate plans data that satisfies constraints fully by combining LLMs and automated planners in accordance with an embodiment.

FIG. 2 illustrates a diagram of a network environment with a platform, language, database, and cloud agnostic automated data processing and generation device in accordance with an embodiment.

FIG. 3 illustrates a system diagram for implementing a platform, language, database, and cloud agnostic automated data processing and generation device having a platform, language, database, and cloud agnostic automated data processing and generation module in accordance with an embodiment.

FIG. 4 illustrates a system diagram for implementing a platform, language, database, and cloud agnostic automated data processing and generation module of FIG. 3 in accordance with an embodiment.

FIG. 5 illustrates a flow chart of a process implemented by the platform, language, database, and cloud agnostic automated data processing and generation module of FIG. 4 automatically generating plans data that satisfies constraints fully by combining LLMs and automated planners in accordance with an embodiment.

### DETAILED DESCRIPTION

Through one or more of its various aspects, embodiments and/or specific features or sub-components of the present disclosure, are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in may include executable code that, when executed by one or more processors, cause the processors to carry out steps necessary to implement the methods of the examples of this technology that are described and illustrated herein.

As is traditional in the field of the present disclosure, example embodiments are described, and illustrated in the drawings, in terms of functional blocks, units and/or modules. Those skilled in the art may appreciate that these blocks, units and/or modules are physically implemented by electronic (or optical) circuits such as logic circuits, discrete components, microprocessors, hard-wired circuits, memory elements, wiring connections, and the like, which may be formed using semiconductor-based fabrication techniques or other manufacturing technologies. In the case of the blocks, units and/or modules being implemented by microprocessors or similar, they may be programmed using software (e.g., microcode) to perform various functions discussed herein and may optionally be driven by firmware and/or software. Alternatively, each block, unit and/or module may be implemented by dedicated hardware, or as a combination of dedicated hardware to perform some functions and a processor (e.g., one or more programmed microprocessors and associated circuitry) to perform other functions. Also, each block, unit and/or module of the example embodiments may be physically separated into two or more interacting and discrete blocks, units and/or modules without departing from the scope of the inventive concepts. Further, the blocks, units and/or modules of the example embodiments may be physically combined into more complex blocks, units and/or modules without departing from the scope of the present disclosure.

As mentioned earlier, travel planning may prove to be a complex task that involves generating a sequence of actions related to visiting places subject to constraints and maximizing some user satisfaction criteria. For example, traditional approaches may rely on problem formulation in a given formal language, extracting relevant travel information from web sources, and use an adequate problem solver to generate a valid solution. For example, various algorithmic approaches have been proposed to find exact or approximate optimal itineraries given POIs and certain constraints. A common limitation of the aforementioned approach may be the need for manual formulation of the optimization or planning problem. More recent works use deep learning techniques for POIs and travel recommendations, lifting the requirement for manual formulation of the planning problem. However, these deep learning models do not account for optimality from a planning perspective.

Conventional LLMs may possess extensive travel domain knowledge and may provide high-level information such as points of interest and potential routes. However, these conventional LLMs are not developed to reason about coherent constraint satisfaction or solution quality. For example, conventional LLM based approaches in travel planning may directly output plans data from user requests using language. Although these conventional LLMs possess extensive travel domain knowledge and provide high-level information like points of interest and potential routes, these LLMs often generate plans data that lack coherence, fail to satisfy constraints fully, and do not guarantee the generation of high-quality solutions, thereby substantially deteriorating model performance.

Moreover, the aforementioned conventional processes primarily evaluated LLMs in classical planning domains such as blocksworld, which may not have had sufficient relevant data during the training stage of these LLMs. Therefore, it may prove to be crucial to benchmark how well a multimodal large language model may readily address the travel planning problem from both constraints and utility perspectives to improve model performance.

Thus, the conventional processes discussed above, face a key challenge for generating data and processing data in an appreciable scale. For example, typical orchestration tools, such as application of conventional LLMs may allow users to define workflows or travel plans (i.e., sequence of actions) to execute a task. However, there appears to be no automation on automatically building those workflows or travel plans from received inputs that may dynamically change due to constraints (i.e., a plan to visit a particular museum may be closed due to weather issue). Also, if the travel plan has to be adapted to different inputs/outputs, it has to be manually modified to account for other inputs as the ones they were defined for, thereby adding complexity to the overall system or process, failing to resolve data integration or synchronization or transfer issues among various computer implemented tools having various heterogenous systems running therein and subjecting the overall systems to malicious cyber-attacks due to the manual nature of defining tasks. Some conventional orchestration tools may incorporate process mining techniques which may allow users to infer workflows from examples. However, these conventional techniques require examples, and additionally, the users should check for the correctness of the induced workflows. Thus, today's conventional orchestration tools fail to dynamically and automatically compose workflows or travel plans data and execute them.

The disclosed embodiments provide a platform that implements a hybrid approach of LLMs and planners to the travel planning domain and benchmark its effectiveness; solves oversubscription planning tasks using such hybrid approach; and benchmark the suboptimality of the travel plans generated by multimodal large language model, such as Generative Pre-Trained Transformer 4 (GPT-4), but the disclosure is not limited thereto. Thus, the embodiments disclosed herein fundamentally address the practical problems of distributing such data over bandwidth-limited communication channels to compute-limited data consumers mechanisms that provide for the construction of real-time data distribution systems that meet any or all of following goals, or any combination thereof: reduced data latency; scalability for large numbers of data consumers; reduced power consumption; reduced space consumption; reduced management complexity and cost; well-defined component interfaces; and independent deployment of components, etc., but the disclosure is not limited thereto.

For example, the present disclosure, through one or more of its various aspects, embodiments, and/or specific features or sub-components, provides, among other features, various systems, servers, devices, methods, media, programs, and platforms for implementing a platform, language, cloud, and database agnostic automated data processing and generation module configured to automatically generate plans data (i.e., travel plans data, but the disclosure is not limited thereto) that satisfies constraints fully by combining LLMs and automated planners, thereby substantially improving performance of the LLMs in outputting high quality plans data, but the disclosure is not limited thereto. For example, the automated data processing and generation module disclosed herein may be configured to automatically generate travel plans data by gathering and combining travel information from LLM and other sources, and then computing a valid travel itinerary using an automated planner that guarantees the solution coherence and quality. The execution of this itinerary may also be monitored by the automated data processing and generation module in order to generate high quality data that suggests opportunities and replan in the event the computed plan data may not be carried out in a real world scenario.

While many of the exemplary embodiments discussed herein focus on applications in the travel domain, it should be understood that the technology described herein may be applied to a wide variety of other application domains, such as biology, physics, and engineering that require generation of plans data meeting some constraints.

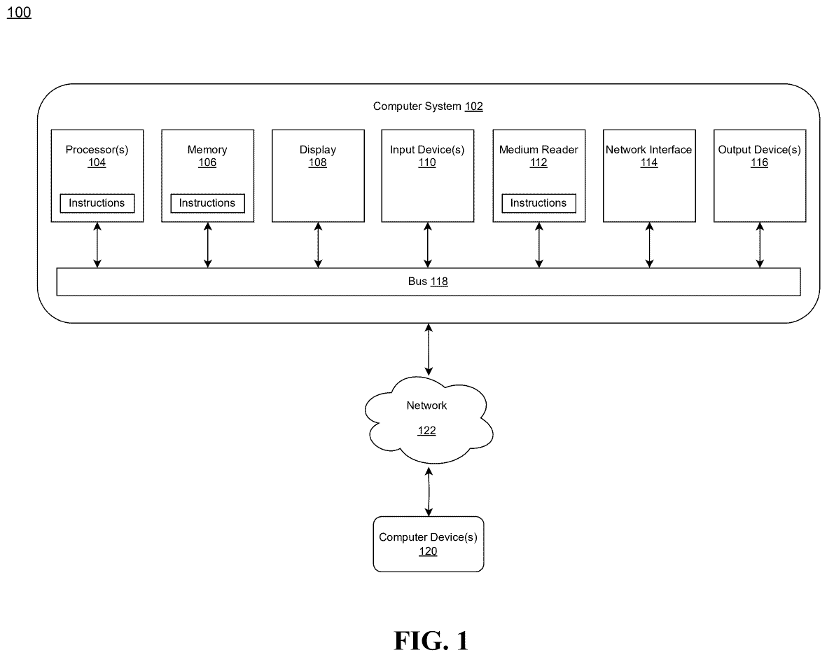

FIG. 1 is an exemplary system 100 for use in implementing a platform, language, database, and cloud agnostic automated data processing and generation module configured to automatically generate plans data (i.e., travel plans data, but the disclosure is not limited thereto) that satisfies constraints fully by combining LLMs and automated planners, thereby substantially improving performance of the LLMs in outputting high quality plans data, but the disclosure is not limited thereto. The system 100 is generally shown and may include a computer system 102, which is generally indicated.

The computer system 102 may include a set of instructions that may be executed to cause the computer system 102 to perform any one or more of the methods or computer-based functions disclosed herein, either alone or in combination with the other described devices. The computer system 102 may operate as a standalone device or may be connected to other systems or peripheral devices. In some embodiments, the computer system 102 may include, or be included within, any one or more computers, servers, systems, communication networks or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term system shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 may be tangible and non-transitory. As used herein, the term “non-transitory” is to be interpreted not as an eternal characteristic of a state, but as a characteristic of a state that may last for a period of time. The term “non-transitory” specifically disavows fleeting characteristics such as characteristics of a particular carrier wave or signal or other forms that exist only transitorily in any place at any time. The processor 104 may be an article of manufacture and/or a machine component. The processor 104 may be configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that may store data and executable instructions, and are non-transitory during the time instructions are stored therein. Again, as used herein, the term “non-transitory” is to be interpreted not as an eternal characteristic of a state, but as a characteristic of a state that may last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions may be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid-state display, a cathode ray tube (CRT), a plasma display, or any other known display.

The computer system 102 may also include at least one input device 110, such as a keyboard, a touch-sensitive input screen or pad, a speech input, a mouse, a remote control device having a wireless keypad, a microphone coupled to a speech recognition engine, a camera such as a video camera or still camera, a cursor control device, a global positioning system (GPS) device, a visual positioning system (VPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 which may be configured to read any one or more sets of instructions, e.g., software, from any of the memories described herein. The instructions, when executed by a processor, may be used to perform one or more of the methods and processes as described herein. In a particular embodiment, the instructions may reside completely, or at least partially, within the memory 106, the medium reader 112, and/or the processor 104 during execution by the computer system 102.

Furthermore, the computer system 102 may include any additional devices, components, parts, peripherals, hardware, software or any combination thereof which are commonly known and understood as being included with or within a computer system, such as, but not limited to, a network interface 114 and an output device 116. The output device 116 may be, but is not limited to, a speaker, an audio out, a video out, a remote control output, a printer, or any combination thereof.

Each of the components of the computer system 102 may be interconnected and communicate via a bus 118 or other communication link. As shown in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, in some embodiments, infrared, near field communication, ultraband, or any combination thereof. Those skilled in the art appreciate that additional networks 122 which are known and understood may additionally or alternatively be used and that the exemplary networks 122 are not limiting or exhaustive. Also, while the network 122 is shown in FIG. 1 as a wireless network, those skilled in the art appreciate that the network 122 may also be a wired network.

The additional computer device 120 is shown in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that may be capable of executing a set of instructions, sequential or otherwise, that specify actions to be taken by that device. Of course, those skilled in the art appreciate that the above-listed devices are merely exemplary devices and that the device 120 may be any additional device or apparatus commonly known and understood in the art without departing from the scope of the present application. In some embodiments, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In some embodiments, the automated data processing and generation module may be platform, language, database, and cloud agnostic that may allow for consistent easy orchestration and passing of data through various components to output a desired result regardless of platform, browser, language, database, and cloud environment. Since the disclosed process, in some embodiments, may be platform, language, database, browser, and cloud agnostic, the automated data processing and generation module may be independently tuned or modified for optimal performance without affecting the configuration or data files. The configuration or data files, in some embodiments, may be written using JSON, but the disclosure is not limited thereto. In some embodiments, the configuration or data files may easily be extended to other readable file formats such as XML, YAML, etc., or any other configuration based languages.

In accordance with various embodiments of the present disclosure, the methods described herein may be implemented using a hardware computer system that executes software programs. Further, in an exemplary, non-limited embodiment, implementations may include distributed processing, component/object distributed processing, and an operation mode having parallel processing capabilities. Virtual computer system processing may be constructed to implement one or more of the methods or functionality as described herein, and a processor described herein may be used to support a virtual processing environment.

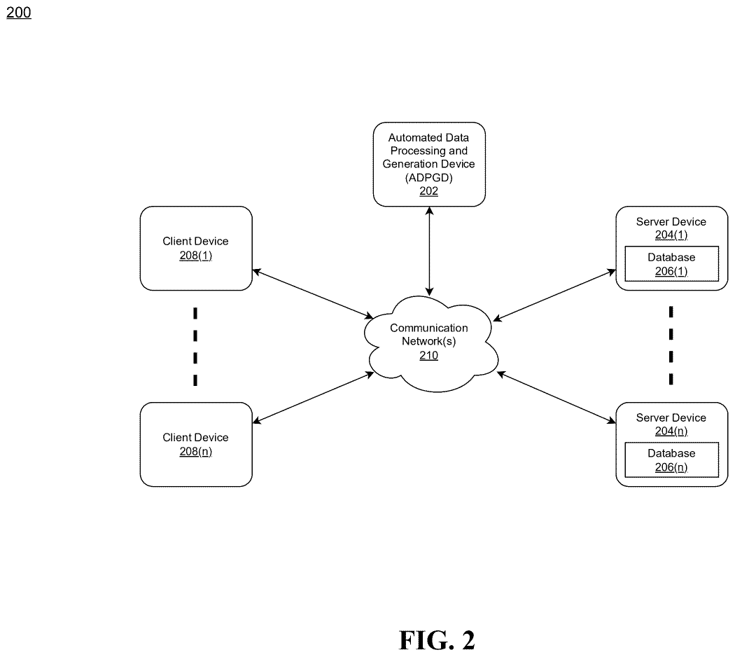

Referring to FIG. 2, a schematic of an exemplary network environment 200 for implementing a language, platform, database, and cloud agnostic automated data processing and generation device (ADPGD) of the instant disclosure is illustrated.

In some embodiments, the above-described problems associated with conventional tools may be overcome by implementing an ADPGD 202 as illustrated in FIG. 2 that may be configured for implementing a platform, language, database, and cloud agnostic automated data processing and generation module configured to automatically generate plans data (i.e., travel plans data, but the disclosure is not limited thereto) that satisfies constraints fully by combining LLMs and automated planners, thereby substantially improving performance of the LLMs in outputting high quality plans data, but the disclosure is not limited thereto. For example, the ADPGD 202 disclosed herein may be configured to automatically generate travel plans data by gathering and combining travel information from LLM and other sources, and then computing a valid travel itinerary using an automated planner that guarantees the solution coherence and quality. The execution of this itinerary may also be monitored by the ADPGD 202 in order to generate high quality data that suggests opportunities and replan in the event the computed plan data may not be carried out in a real world scenario.

The ADPGD 202 may have one or more computer system 102s, as described with respect to FIG. 1, which in aggregate provide the necessary functions.

The ADPGD 202 may store one or more applications that may include executable instructions that, when executed by the ADPGD 202, cause the ADPGD 202 to perform actions, such as to transmit, receive, or otherwise process network messages, in some embodiments, and to perform other actions described and illustrated below with reference to the figures. The application(s) may be implemented as modules or components of other applications. Further, the application(s) may be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s), and even the ADPGD 202 itself, may be located in virtual server(s) running in a cloud-based computing environment rather than being tied to one or more specific physical network computing devices. Also, the application(s) may be running in one or more virtual machines (VMs) executing on the ADPGD 202. Additionally, in one or more embodiments of this technology, virtual machine(s) running on the ADPGD 202 may be managed or supervised by a hypervisor.

In the network environment 200 of FIG. 2, the ADPGD 202 may be coupled to a plurality of server devices 204(1)-204(n) that hosts a plurality of databases 206(1)-206(n), and also to a plurality of client devices 208(1)-208(n) via communication network(s) 210. A communication interface of the ADPGD 202, such as the network interface 114 of the computer system 102 of FIG. 1, operatively couples and communicates between the ADPGD 202, the server devices 204(1)-204(n), and/or the client devices 208(1)-208(n), which may all be coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the ADPGD 202, the server devices 204(1)-204(n), and/or the client devices 208(1)-208(n) may be coupled together via other topologies. Additionally, the network environment 200 may include other network devices such as one or more routers and/or switches, in some embodiments, which are well known in the art and thus may not be described herein.

By way of example only, the communication network(s) 210 may include local area network(s) (LAN(s)) or wide area network(s) (WAN(s)), and may use TCP/IP over Ethernet and industry-standard protocols, although other types and/or numbers of protocols and/or communication networks may be used. The communication network(s) 210 in this example may employ any suitable interface mechanisms and network communication technologies including, in some embodiments, teletraffic in any suitable form (e.g., voice, modem, and the like), Public Switched Telephone Network (PSTNs), Ethernet-based Packet Data Networks (PDNs), combinations thereof, and the like.

The ADPGD 202 may be a standalone device or integrated with one or more other devices or apparatuses, such as one or more of the server devices 204(1)-204(n). In some embodiments, the ADPGD 202 may be hosted by one of the server devices 204(1)-204(n), and other arrangements may also be possible. Moreover, one or more of the devices of the ADPGD 202 may be in the same or a different communication network including one or more public, private, or cloud networks, in some embodiments.

The plurality of server devices 204(1)-204(n) may be the same or similar to the computer system 102 or the computer device 120 as described with respect to FIG. 1, including any features or combination of features described with respect thereto. In some embodiments, any of the server devices 204(1)-204(n) may include, among other features, one or more processors, a memory, and a communication interface, which may be coupled together by a bus or other communication link, although other numbers and/or types of network devices may be used. The server devices 204(1)-204(n) in this example may process requests received from the ADPGD 202 via the communication network(s) 210 according to the HTTP-based and/or JSON protocol, in some embodiments, although other protocols may also be used.

The server devices 204(1)-204(n) may be hardware or software or may represent a system with multiple servers in a pool, which may include internal or external networks. The server devices 204(1)-204(n) hosts the databases 206(1)-206(n) that may be configured to store metadata sets, data quality rules, and newly generated data.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a master/slave approach, whereby one of the network computing devices of the server devices 204(1)-204(n) operates to manage and/or otherwise coordinate operations of the other network computing devices.

In some embodiments, the server devices 204(1)-204(n) may operate as a plurality of network computing devices within a cluster architecture, a peer-to peer architecture, virtual machines, or within a cloud architecture. Thus, the technology disclosed herein is not to be construed as being limited to a single environment and other configurations and architectures may also be envisaged.

The plurality of client devices 208(1)-208(n) may also be the same or similar to the computer system 102 or the computer device 120 as described with respect to FIG. 1, including any features or combination of features described with respect thereto. Client device in this context refers to any computing device that interfaces to communications network(s) 210 to obtain resources from one or more server devices 204(1)-204(n) or other client devices 208(1)-208(n).

In some embodiments, the client devices 208(1)-208(n) in this example may include any type of computing device that may facilitate the implementation of the ADPGD 202 that may efficiently provide a platform for implementing a platform, language, database, and cloud agnostic automated data processing and generation module configured to automatically generate plans data (i.e., travel plans data, but the disclosure is not limited thereto) that satisfies constraints fully by combining LLMs and automated planners, thereby substantially improving performance of the LLMs in outputting high quality plans data, but the disclosure is not limited thereto.

The client devices 208(1)-208(n) may run interface applications, such as standard web browsers or standalone client applications, which may provide an interface to communicate with the ADPGD 202 via the communication network(s) 210 in order to communicate user requests. The client devices 208(1)-208(n) may further include, among other features, a display device, such as a display screen or touchscreen, and/or an input device, such as a keyboard, in some embodiments.

Although the exemplary network environment 200 with the ADPGD 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as may be appreciated by those skilled in the relevant art(s).

One or more of the devices depicted in the network environment 200, such as the ADPGD 202, the server devices 204(1)-204(n), or the client devices 208(1)-208(n), in some embodiments, may be configured to operate as virtual instances on the same physical machine. In some embodiments, one or more of the ADPGD 202, the server devices 204(1)-204(n), or the client devices 208(1)-208(n) may operate on the same physical device rather than as separate devices communicating through communication network(s) 210. Additionally, there may be more or fewer ADPGDs 202, server devices 204(1)-204(n), or client devices 208(1)-208(n) than illustrated in FIG. 2. In some embodiments, the ADPGD 202 may be configured to send code at run-time to remote server devices 204(1)-204(n), but the disclosure is not limited thereto.

In addition, two or more computing systems or devices may be substituted for any one of the systems or devices in any example. Accordingly, principles and advantages of distributed processing, such as redundancy and replication also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

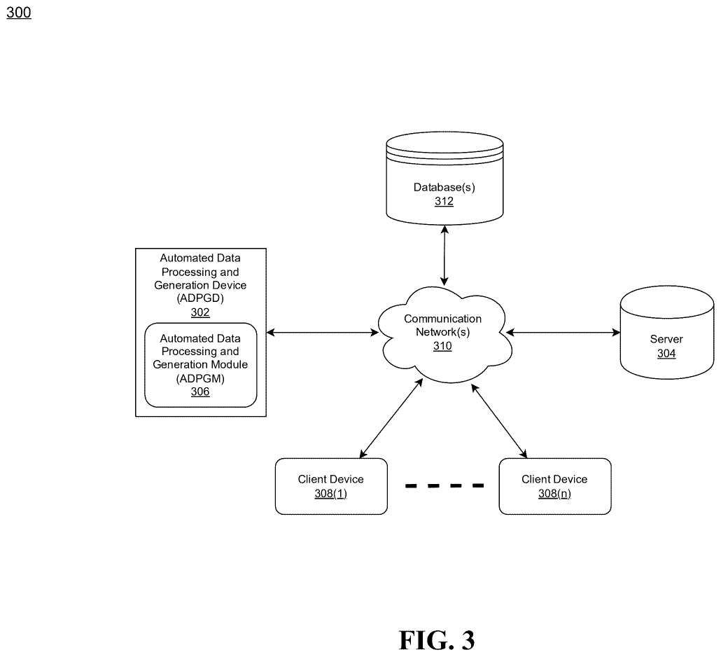

FIG. 3 illustrates a system diagram for implementing a platform, language, and cloud agnostic ADPGD having a platform, language, database, and cloud agnostic automated data processing and generation module (ADPGM) in accordance with an embodiment.

As illustrated in FIG. 3, the system 300 may include an ADPGD 302 within which an ADPGM 306 may be embedded, a server 304, a database(s) 312, a plurality of client devices 308(1) . . . 308(n), and a communication network 310.

In some embodiments, the ADPGD 302 including the ADPGM 306 may be connected to the server 304, and the database(s) 312 via the communication network 310. The ADPGD 302 may also be connected to the plurality of client devices 308(1) . . . 308(n) via the communication network 310, but the disclosure is not limited thereto.

According to exemplary embodiment, the ADPGD 302 is described and shown in FIG. 3 as including the ADPGM 306, although it may include other rules, policies, modules, databases, or applications, etc. In some embodiments, the database(s) 312 may be configured to store ready to use modules written for each Application Programming Interface (API) for all environments. Although only one database is illustrated in FIG. 3, the disclosure is not limited thereto. Any number of desired databases may be utilized for use in the disclosed invention herein. The database(s) 312 may be a mainframe database, a log database that may produce programming for searching, monitoring, and analyzing machine-generated data via a web interface, etc., but the disclosure is not limited thereto.

In some embodiments, the ADPGM 306 may be configured to receive real-time feed of data from the plurality of client devices 308(1) . . . 308(n) and secondary sources via the communication network 310.

As may be described below, the ADPGM 306 may be configured to: establish a communication link among the data planning system, a multimodal large language model, an automated planning device, and a plurality of internal or external systems via a communication interface; receive, by the data planning system, user inputs data provided by a user regarding a configurable pre-desired travel plan to a configurable pre-desired travel location; execute, in response to receiving the user inputs data by the data planning system, an information retrieval process and a planning process to output planning data corresponding to the configurable pre-desired travel plan and the configurable pre-desired travel location by integrating the multimodal large language model and the automated planning device within the data planning system via the communication interface; wherein in executing the information retrieval process, the processor may be further configured to: execute a series of queries to the multimodal large language model and the plurality of internal or external systems, via corresponding application programming interface, that may provide data corresponding to the configurable pre-desired location; generate, in response to executing the series of queries, a plurality of planning tasks data to be utilized by the planning process to output the planning data; wherein in executing the planning process, the processor may be further configured to: execute a series of algorithmic sub-tasks that utilize the plurality of planning tasks data; and automatically output the planning data in response to executing the series of algorithmic sub-tasks, wherein each sub-task utilize information from prior plans to inform computation, thereby improving performance of the data planning system in outputting the planning data and displaying the planning data onto a user interface within the data planning system, but the disclosure is not limited thereto.

The plurality of client devices 308(1) . . . 308(n) are illustrated as being in communication with the ADPGD 302. In this regard, the plurality of client devices 308(1) . . . 308(n) may be “clients” (e.g., customers) of the ADPGD 302 and are described herein as such. Nevertheless, it is to be known and understood that the plurality of client devices 308(1) . . . 308(n) need not necessarily be “clients” of the ADPGD 302, or any entity described in association therewith herein. Any additional or alternative relationship may exist between either or both of the plurality of client devices 308(1) . . . 308(n) and the ADPGD 302, or no relationship may exist.

The first client device 308(1) may be, in some embodiments, a smart phone. Of course, the first client device 308(1) may be any additional device described herein. The second client device 308(n) may be, in some embodiments, a personal computer (PC). Of course, the second client device 308(n) may also be any additional device described herein. In some embodiments, the server 304 may be the same or equivalent to the server device 204 as illustrated in FIG. 2.

The process may be executed via the communication network 310, which may comprise plural networks as described above. In an embodiment, one or more of the plurality of client devices 308(1) . . . 308(n) may communicate with the ADPGD 302 via broadband or cellular communication. Of course, these embodiments are merely exemplary and are not limiting or exhaustive.

The computing device 301 may be the same or similar to any one of the client devices 208(1)-208(n) as described with respect to FIG. 2, including any features or combination of features described with respect thereto. The ADPGD 302 may be the same or similar to the ADPGD 202 as described with respect to FIG. 2, including any features or combination of features described with respect thereto.

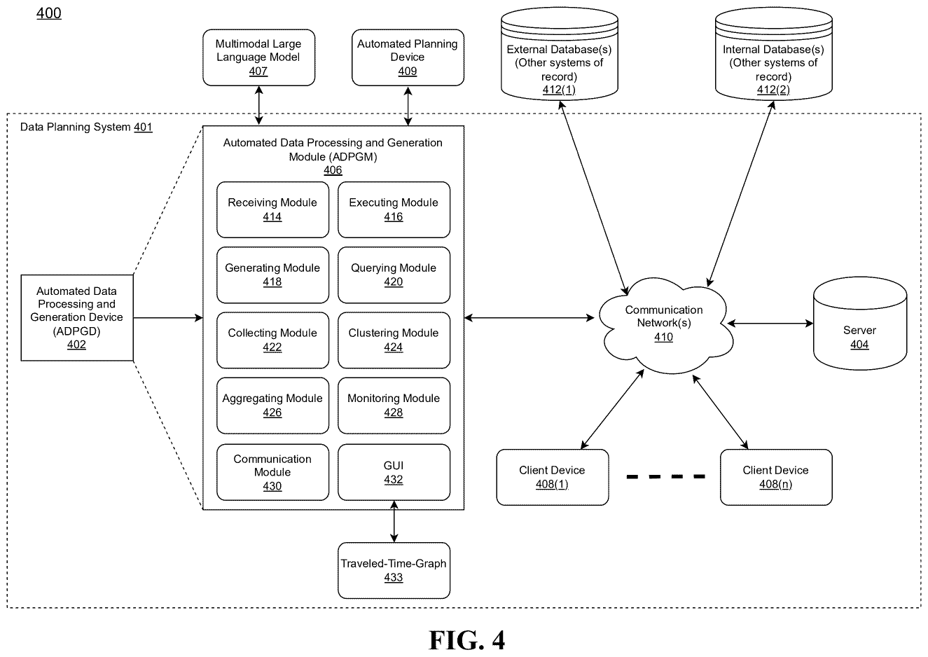

FIG. 4 illustrates a system diagram for implementing a platform, language, database, and cloud agnostic ADPGM of FIG. 3 in accordance with an exemplary embodiment.

In some embodiments, the system 400 may include a platform, language, database, and cloud agnostic ADPGD 402 within which a platform, language, database, and cloud agnostic ADPGM 406 may be embedded, a server 404, a multimodal large language model 407, an automated planning device 409, external database(s) 412(1), internal database(s) 412(2), and a communication network 410. In some embodiments, server 404 may comprise a plurality of servers located centrally or located in different locations, but the disclosure is not limited thereto.

In some embodiments, the ADPGD 402 including the ADPGM 406 may be connected to the server 404, the multimodal large language model 407, the automated planning device 409, the external database(s) 412(1), and internal database(s) 412(2) via the communication network 410. The ADPGD 402 may also be connected to the plurality of client devices 408(1)-408(n) via the communication network 410, but the disclosure is not limited thereto. The ADPGM 406, the server 404, the plurality of client devices 408(1)-408(n), the database(s) 412(1), 412(2), the communication network 410 as illustrated in FIG. 4 may be the same or similar to the ADPGM 306, the server 304, the plurality of client devices 308(1)-308(n), the database(s) 312, the communication network 310, respectively, as illustrated in FIG. 3.

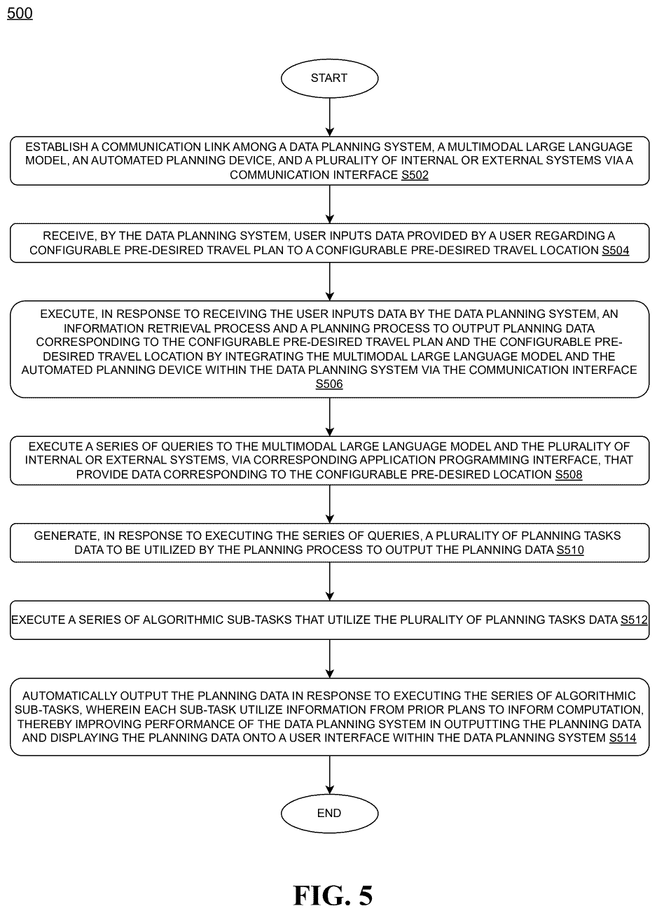

In some embodiments, as illustrated in FIG. 4, the ADPGM 406 may include a receiving module 414, an executing module 416, a generating module 418, a querying module 420, a collecting module 422, a clustering module 424, an aggregating module 426, a monitoring module 428, a communication module 430, and a Graphical User Interface (GUI) 432. In some embodiments, interactions and data exchange among these modules included in the ADPGM 406 provide the advantageous effects of the disclosed invention. Functionalities of each module of FIG. 4 may be described in detail below with reference to FIGS. 4-5.

In some embodiments, each of the receiving module 414, executing module 416, generating module 418, querying module 420, collecting module 422, clustering module 424, aggregating module 426, monitoring module 428, and the communication module 430 of the ADPGM 406 of FIG. 4 may be physically implemented by electronic (or optical) circuits such as logic circuits, discrete components, microprocessors, hard-wired circuits, memory elements, wiring connections, and the like, which may be formed using semiconductor-based fabrication techniques or other manufacturing technologies.

In some embodiments, each of the receiving module 414, executing module 416, generating module 418, querying module 420, collecting module 422, clustering module 424, aggregating module 426, monitoring module 428, and the communication module 430 of the ADPGM 406 of FIG. 4 may be implemented by microprocessors or similar, and may be programmed using software (e.g., microcode) to perform various functions discussed herein and may optionally be driven by firmware and/or software.

Alternatively, in some embodiments, each of the receiving module 414, executing module 416, generating module 418, querying module 420, collecting module 422, clustering module 424, aggregating module 426, monitoring module 428, and the communication module 430 of FIG. 4 may be implemented by dedicated hardware, or as a combination of dedicated hardware to perform some functions and a processor (e.g., one or more programmed microprocessors and associated circuitry) to perform other functions, but the disclosure is not limited thereto. In some embodiments, the ADPGM 406 of FIG. 4 may also be implemented by cloud-based deployment.

In some embodiments, each of the receiving module 414, executing module 416, generating module 418, querying module 420, collecting module 422, clustering module 424, aggregating module 426, monitoring module 428, and the communication module 430 the ADPGM 406 of FIG. 4 may be called via corresponding API, but the disclosure is not limited thereto. For example, in some embodiments, the receiving module 414 may be called via a first API, the executing module 416 may be called via a second API, the generating module 418 may be called via a third API, the querying module 420 may be called via a fourth API, the collecting module 422 may be called via a fifth API, the clustering module 424 may be called via a sixth API, the aggregating module 426 may be called via a seventh API, the monitoring module 428 may be called via an eight API, and the communication module 430 may be called via a ninth API. In some embodiments, calls may also be made using event-based message interfaces in addition to APIs. An event-based message interface may be a design pattern that enables communication between services by defining events and handlers that process them. This approach may allow for efficient communication and decoupled components, which may lead to more flexible and modular systems.

In some embodiments, the process implemented by the ADPGM 406 may be executed via the communication module 430, and the communication network 410, which may comprise plural networks as described above. In some embodiments, in an exemplary embodiment, the various components of the ADPGM 406 may communicate with the server 404, the multimodal large language model 407, the automated device 409, the external database(s) 412(1), and the internal database(s) 412(2), and other systems of records via the communication module 430 and the communication network 410 and the results may be displayed onto the GUI 432. Of course, these embodiments are merely exemplary and are not limiting or exhaustive. The database(s) 412(1), 412(2) may include the databases included within the private cloud and/or public cloud and the server 404 may include one or more servers within the private cloud and the public cloud.

FIG. 5 illustrates a flow chart of a process 500 implemented by the ADPGM 406 of FIG. 4 for automatically generating plans data that satisfies constraints fully by combining LLMs and automated planners in accordance with an embodiment. It may be appreciated that the illustrated process 500 and associated steps may be performed in a different order, with illustrated steps omitted, with additional steps added, or with a combination of reordered, combined, omitted, or additional steps.

Referring to FIGS. 4-5, in some embodiments, at step S502, the process 500 may include establishing a communication link, by calling the communication module 430 (see FIG. 4) via the ninth API, among a data planning system 401, the multimodal large language model 407, the automated planning device 409, a plurality of internal or external systems (i.e., external database(s) 412(1), internal database(s) 412(2) or other system of records) by utilizing the client device 408(1)-408(n) via a communication interface within the GUI 432. In some embodiments, the ADPGD 402, the ADPGM 406, the client device 408(1)-408(n), the communication network(s) 410, and the server 404 may collectively form the data planning system 401. In some embodiments, the data planning system 401 may simply be referred to as a generative model that outputs data based on inputs.

In some embodiments, at step S504, the process 500 implemented by the ADPGM 406 may include receiving, by the data planning system 401 by calling the receiving module 414 via the first API, user inputs data provided by a user regarding a configurable pre-desired travel plan to a configurable pre-desired travel location. The user describes his/her request in natural language, asking data planning system 401 to generate a travel itinerary under a set of preferences and conditions. The user inputs data may include one or more of the following data: number of travelers; city, region, or country to visit; total budget; time span in days; user preferences on food, places, flight, hotel, service provider, etc., but the disclosure is not limited thereto. The data planning system 401 may have a list of parameters that may allow a configurable performance. These parameters may include: the number of hours a day plan can take, the number of POIs to consider in as candidate in a plan request, etc., but the disclosure is not limited thereto.

The input data and the parameters of constraints discussed above may be utilized by the ADPGM 406 to formulate a planning problem that captures the user's goals and general preferences. In some embodiments, the general preference of visiting each POI extracted by the multimodal large language model 407 may be a proxy of the user satisfaction of visiting those POIs. The formulated planning problem may be then solved using automated planner device 409, which takes into account the real-world constraints and generates an optimal travel plan. The automated planner device 409 may consider factors such as commute times, time to spend at a POI, and general preferences to create a plan that maximizes user satisfaction or utility while being feasible. By explicitly representing the planning problem and using automated planner device 409, the ADPGM 406 may be configured to ensure that the generated plans are sound (valid), comply with constraints, and are optimal.

For example, in some embodiments, at step S506, the process 500 implemented by the ADPGM 406 may include, executing by calling the executing module 416 via the second API, in response to receiving the user inputs data by the data planning system 401, an information retrieval process and a planning process to output planning data corresponding to the configurable pre-desired travel plan and the configurable pre-desired travel location by integrating the multimodal large language model and the automated planning device within the data planning system 401 via the communication interface.

The information retrieval process collects data and facts needed to compose formal planning tasks. This information may be information sought from external or internal information providers (e.g., google maps, the user, websites for tourist locations, etc.), or may be retrieved from a database (i.e., external database(s) 412(1), internal database(s) 412(2), or system of records) of past interactions and solutions.

If tasks are specified in a formal language such as PDDL, they may be solved by automated planners (e.g., the automated planning device 409), specialized solvers that compute plans that transform an initial state into a state where a set of goals are achieved. The planning step build the planning tasks and call the planner to get the solution to build travel plan for the user. Alternatively, the task maybe compiled into an optimization problem to compute solutions.

For example, in executing the information retrieval process of step S506, at step S508, the process 500 implemented by the ADPGM 406 may include executing, by calling the executing module 416 via the second API, a series of queries to the multimodal large language model 407 and to the plurality of internal or external systems (i.e., external database(s) 412(1), internal database(s) 412(2) or other system of records), that provide data corresponding to the configurable pre-desired location. In executing the information retrieval process, at step S510, the process 500 implemented by the ADPGM 406 may further include, generating, by calling the generating module 418 via the third API, in response to executing the series of queries, a plurality of planning tasks data to be utilized by the planning process to output the planning data onto the GUI 432 (see FIG. 4).

For example, in some embodiments, in executing the series of queries to the multimodal large language model 407, at step S506, the process 500 implemented by the ADPGM 406 may include: (i) requesting for a set of candidate POIs for an input city or region corresponding to the configurable pre-desired travel location; (ii) for each provided POI in (i), querying, by calling the querying module 420 via the fourth API, for a score that indicates a general popularity of the POIs; and (iii) for each provided POI in (i), querying, by calling the querying module 420 via the fourth API, for a time a user is recommended to spend in an activity.

In some embodiments, in executing the series of queries to the plurality of internal or external systems (i.e., external database(s) 412(1), internal database(s) 412(2) or other system of records), at step S506, the process 500 implemented by the ADPGM 406 may include: querying, by calling the querying module 420 via the fourth API, a map-service API to collect information data corresponding to the configurable pre-desired travel location to populate a travel-time graph 433; and collecting, by calling the collecting module 422 via the fifth API, for each pair of POIs among the set of candidate POIs, an estimated time to move from one place to another place within the travel-time graph 433.

In some embodiments, in executing the series of queries to the plurality of internal or external systems (i.e., external database(s) 412(1), internal database(s) 412(2) or other system of records), at step S506, the process 500 implemented by the ADPGM 406 may include: querying, by calling the querying module 420 via the fourth API, a place information service to obtain a schedule data with opening or closing hours for each POIs and an estimated cost per person.

In some embodiments, in executing the series of queries to the plurality of internal or external systems (i.e., external database(s) 412(1), internal database(s) 412(2) or other system of records), at step S506, the process 500 implemented by the ADPGM 406 may further include, querying, by calling the querying module 420 via the fourth API, an internal or external database (i.e., the internal database(s) 412(1) or the external database(s) 412(2)) to collect travel recommendation preference data.

For example, in some embodiments, in executing the series of queries to the plurality of internal or external systems (i.e., external database(s) 412(1), internal database(s) 412(2) or other system of records), at step S506, the process 500 implemented by the ADPGM 406 may further include, querying, by calling the querying module 420 via the fourth API, an internal or an external data source (i.e., external database(s) 412(1), internal database(s) 412(2) or other system of records) for past solutions similar to plans corresponding to the configurable pre-desired travel plan.

For example, the inputs to each planning episode may include: the desired city, C; the number of POIs to consider, N; and the maximum number of hours the travel plan should take, H. The first step in the travel planning process is to extract the corresponding information to those requirements: a set of size N of POIs in the city C with associated relevant information. The ADPGM 406 may be configured to utilize a sequence of prompts to the multimodal large language model 407, that returns the data it requires to compose a travel plan. The result of each prompt is included in the context of the next call. Example of a prompt to provide N POIs, may include “give me a list of 10 tourist points of interest by their full name for the city of Paris. Present it as a comma separated list of places . . . ”. Example of a prompt to give scores to POIs may include “Given, this information, for the places mentioned, assign a number from 1 to 10 based on how popular they are for tourists . . . ”.

The summary of steps may include the following, but the disclosure is not limited thereto.
i) For a given city C, the ADPGM 406 asks the multimodal large language model 407 to return a set P of N tourist POIs. Each POI p E P may become a goal of the planning problem as visit(p).
ii) For each POI provided before, the ADPGM 406 gets the rating or utility of the POI by asking the for the popularity expressed in a utility value, for example, between 1 and 10, with 10 as the maximum utility, but the disclosure is not limited thereto. The ADPGM 406 uses this value as the POI's utility, utility(p, u). The sum of utilities of POIs in any plan may provide the total plan utility or plan value. Since the ADPGM 406 address issues with oversubscription planning, not all POIs may necessarily be visited in the plans.
iii) Then, the ADPGM 406 asks for the time one should spend in each location; this information is asked to be returned in units of 15 minutes, and may define the visit-time (p, t) property.

With the set of POIs returned by the multimodal large language model 407, ADPGM 406 may query a service to get the travel time between POIs such as the google places API and generate a travel-times graph (e.g., traveled-time-graph 433) mentioned earlier. All the accumulated travel information described above may then be fed to the automated planning device 409.

For the multimodal large language model 407, the task of generating this plan with the previous information given in the prompt, may involve selecting a subset of POIs that may fit in the schedule. That is considering the visiting time of POIs and the commute time between POIs, and then provide the best plan by utility to the user. Utility may correspond to the sum of the utilities of POIs in the plan.

The call to the automated planning device 409 for travel planning may include the following steps. Automated planning may be the artificial intelligence field that builds domain-independent solvers which may produce a sequence of actions (plans) to transform a given initial state into a state where a set of goals have been achieved. A planning task in automated planning by the automated planning device 409 may be specified in a declarative language (typically, PDDL discussed earlier) comprising an action model (domain) and a problem description where the initial state, the goals and the metric to optimize are defined. Oversubscription planning focuses on the class of tasks where not all goals may be achieved because the availability of bounded resources. This is the case for travel planning, since a tourist may be willing to visit more POIs that one may handle in a day itinerary. In oversubscription planning, some, or even all goals, may be deemed as softgoals, meaning that a plan is still valid if they are not reached in the final state.

Exemplary PDDL definition of the visit action may include:

```
(:action visit
  :parameters (?vloc - location
      ?vt0 - time
      ?vtvisit - time
      ?vtf - time)
  :precondition
    (and (normal_mode)
        (current_time ?vt0)
        (visited_time ?vloc ?vtvisit)
        (user_at ?vloc)
        (logic_sum ?vt0 ?vtvisit ?vtf))
  :effect
    (and (visited ?vloc)
        (not (current_time ?vt0))
        (current_time ?vtf)
        (increase (total-cost)
          (visit_cost ?vloc))))
```

For example, in executing the planning process of step S506, at step S512, the process 500 implemented by the ADPGM 406 may include executing, by calling the executing module 416 via the second API, a series of algorithmic sub-tasks that utilize the plurality of planning tasks data. In executing the planning process of step S506, at step S512, the process 500 implemented by the ADPGM 406 may also include automatically outputting the planning data in response to executing the series of algorithmic sub-tasks. Each sub-task may utilize information from prior plans to inform computation, thereby improving performance of the data planning system 401 in outputting the planning data and displaying the planning data onto GUI 432 within the data planning system 401.

In some embodiments, a format of the planning data output from the data planning system 401 at step S512 may include one or more of the following: plain text, comma separated vectors, JSON objects file format, executable python code, etc., but the disclosure is not limited thereto. Some instructions also specified syntax for specific data types. For instances, asking for time, the instructions may indicate “HH:MM”.

In some embodiments, in executing the series of algorithmic sub-tasks at step S512, the process 500 implemented by the ADPGM 406 may also include: (i) executing a trip segregation sub-task that may include, for the set of candidate POIs, geographically clustering, by calling the clustering module 424 via the sixth API, using a clustering algorithm that considers one cluster of POIs per each day in the trip; (ii) executing a task generation sub-task that may include, for each cluster of POIs and associated planning tasks data for each cluster of POIs retrieved by the information retrieval process, translating each piece of information into a state variable represented into PDDL; (iii) executing a task resolution sub-task that may include, outputting the planning data using the PDDL generated in (ii), as well as preferences and constraints defined by the user by utilizing the automated planning device 409 and outputting a sequence of actions that maximizes the score for a given day; iv) executing a plan composition sub-task that may include, aggregating, by calling the aggregating module 426 via the seventh API, in a two-level solution that may include: a list of days, with a city and location for a recommended accommodation requested by the user; and a day plan for each day, that may include a suggested schedule for visiting the POIs, eating in restaurants, and moving from one place to another place, but the disclosure is not limited thereto; and v) executing a plan monitoring sub-task by calling the monitoring module 428 via the eight API, that may include monitoring execution of the planning data output from the data planning system 401 and outputting a replan data in an event the planning data output from the data planning system 401 may not be carried out in a real world scenario.

For example, the ADPGM 406 may be configured to address two planning characteristics that cover the relation between LLMs reasoning capabilities and planning: over-subscription and optimality. Planning under oversubscription deals with tasks where there is no possible plan that achieves all goals given as input. For instance, when the automated planning device 409 is given 50 POIs to visit in Paris in one day, there is no reasonable travel plan that may achieve all those goals under that time constraint. Therefore, a valid/optimal solution may consider the plan that achieves the subset of goals that maximize user satisfaction or utility under the given constraints.

The Table 1 lists ahigh-level description of actions in the PDDL travel domain utilized by the ADPGM 406 as disclosed herein, but the disclosure is not limited thereto.

TABLE 1

| Action | Description |
|---|---|
| Move | A generic action representing the time spent in going from |
| | one point to another. This includes walking short distances |
| | or taking public transport |
| Visit | The activity of spending time in a POI. For instance, visiting |
| | a park, taking a guided tour in a museum, etc. Doing this |
| | action add the assigned score to the user's total score |
| Eat | The activity of having a meal in a recommended restaurant. |
| | This action increases the total score by the restaurant score |
| Change | A generic action representing a move to a new recommended |
| | accommodation. For instance, this is used in multi-day trips |
| | involving several hotels |

TABLE 2
lists a high-level description of a PDDL problem utilized by the ADPGM
406 as disclosed herein, but the disclosure is not limited thereto.

| Section | Components | PDDL Example |
|---|---|---|
| Objects | POIs | prado_musem, retiro_park |
| | Restaurants | pez_tortilla, la_vinoteca |
| | Accommodation | (wellington_hotel) |
| Initial State | POI/restaurant scores | (score prado_museum 10) |
| | POI time to visit | (time_visit prado_museum 120) |
| | Accommodation as starting point | (user_at wellington_hotel) |
| | POI to POI time to move (including | (time_to_move prado_museum |
| | accommodation) | retiro_park 10) |
| Goals | Soft-goal of visiting each POI | (visit prado_museum) |
| Metric | Maximize the cumulative score of | (maximize (total_score)) |
| | visited POIs/restaurants | |

In some embodiments, the ADPGD 402 may include a memory (e.g., a memory 106 as illustrated in FIG. 1) which may be a non-transitory computer readable medium that may be configured to store instructions for implementing a platform, language, database, and cloud agnostic ADPGM 406 for implementing artificial intelligence and machine learning models and techniques to audit and enforce conditional fairness via optimal transport regardless of whether conditioning variable has many levels and validate efficacy of the implemented algorithms on real-world datasets as disclosed herein. The ADPGD 402 may also include a medium reader (e.g., a medium reader 112 as illustrated in FIG. 1) which may be configured to read any one or more sets of instructions, e.g., software, from any of the memories described herein. The instructions, when executed by a processor embedded within the ADPGM 406 or within the ADPGD 402, may be used to perform one or more of the processes as described herein. In a particular embodiment, the instructions may reside completely, or at least partially, within the memory 106, the medium reader 112, and/or the processor 104 (see FIG. 1) during execution by the ADPGD 402.

In some embodiments, the instructions, when executed, may cause a processor embedded within the ADPGM 406 or the ADPGD 402 to perform the following: establishing a communication link among the data planning system, a multimodal large language model, an automated planning device, and a plurality of internal or external systems via a communication interface; receiving, by the data planning system, user inputs data provided by a user regarding a configurable pre-desired travel plan to a configurable pre-desired travel location; executing, in response to receiving the user inputs data by the data planning system, an information retrieval process and a planning process to output planning data corresponding to the configurable pre-desired travel plan and the configurable pre-desired travel location by integrating the multimodal large language model and the automated planning device within the data planning system via the communication interface; wherein in executing the information retrieval process, the instructions, when executed, may cause the processor 104 to further perform the following: executing a series of queries to the multimodal large language model and the plurality of internal or external systems, via corresponding application programming interface, that provide data corresponding to the configurable pre-desired location; generating, in response to executing the series of queries, a plurality of planning tasks data to be utilized by the planning process to output the planning data; wherein in executing the planning process, the instructions, when executed, may cause the processor 104 to further perform the following: executing a series of algorithmic sub-tasks that utilize the plurality of planning tasks data; and automatically outputting the planning data in response to executing the series of algorithmic sub-tasks, wherein each sub-task utilize information from prior plans to inform computation, thereby improving performance of the data planning system in outputting the planning data and displaying the planning data onto a user interface within the data planning system. In some embodiments, the processor may be the same or similar to the processor 104 as illustrated in FIG. 1 or the processor embedded within the ADPGD 202, ADPGD 302, ADPGD 402, and ADPGM 406 which may be the same or similar to the processor 104.

In some embodiments, in executing the series of queries to the multimodal large language model, the instructions, when executed, may cause the processor 104 to further perform the following: (i) requesting for a set of candidate POIs for an input city or region corresponding to the configurable pre-desired travel location; (ii) for each provided POI in (i), querying for a score that indicates a general popularity of the POIs; and (iii) for each provided POI in (i), querying for a time a user is recommended to spend in an activity.

In some embodiments, in executing the series of queries to the plurality of internal or external systems, the instructions, when executed, may cause the processor 104 to further perform the following: querying a map-service API to collect information data corresponding to the configurable pre-desired travel location to populate a travel-time graph; and collecting, for each pair of POIs among the set of candidate POIs, an estimated time to move from one place to another place within the travel-time graph.

In some embodiments, the instructions, when executed, may cause the processor 104 to further perform the following: querying a place information service to obtain a schedule data with opening or closing hours for each POIs and an estimated cost per person.

In some embodiments, the instructions, when executed, may cause the processor 104 to further perform the following: querying an internal or external database to collect travel recommendation preference data.

In some embodiments, the instructions, when executed, may cause the processor 104 to further perform the following: querying an internal or an external data source for past solutions similar to plans corresponding to the configurable pre-desired travel plan.

In some embodiments, in executing the series of algorithmic sub-tasks, the instructions, when executed, may cause the processor 104 to further perform the following: (i) executing a trip segregation sub-task that may include, for the set of candidate POIs, geographically clustering using a clustering algorithm that considers one cluster of POIs per each day in the trip; (ii) executing a task generation sub-task that may include, for each cluster of POIs and associated planning tasks data for each cluster of POIs retrieved by the information retrieval process, translating each piece of information into a state variable represented into a PDDL; (iii) executing a task resolution sub-task that may include, outputting the planning data using the PDDL generated in (ii), as well as preferences and constraints defined by the user by utilizing the automated planning device and outputting a sequence of actions that maximizes the score for a given day; iv) executing a plan composition sub-task that may include, aggregating in a two-level solution that includes: a list of days, with a city and location for a recommended accommodation requested by the user; and a day plan for each day, that may include a suggested schedule for visiting the POIs, eating in restaurants, and moving from one place to another place, but the disclosure is not limited thereto; and v) executing a plan monitoring sub-task that may include monitoring execution of the planning data output from the data planning system and outputting a replan data in an event the planning data output from the data planning system may not be carried out in a real world scenario.

In some embodiments according to the non-transitory computer readable medium, a format of the planning data output from the data planning system may include one or more of the following: plain text, comma separated vectors, JSON objects, and executable python code, but the disclosure is not limited thereto.

In some embodiments according to the non-transitory computer readable medium, the user inputs data may include one or more of the following data: number of travelers; city, region, or country to visit; total budget; time span in days; and user preferences on food, places, flight, hotel, and service provider, but the disclosure is not limited thereto.

In some embodiments as disclosed above in FIGS. 1-5, technical improvements effected by the instant disclosure may include a platform for implementing a platform, language, database, and cloud agnostic automated data processing and generation module configured to automatically generate plans data (i.e., travel plans data, but the disclosure is not limited thereto) that satisfies constraints fully by combining LLMs and automated planners, thereby substantially improving performance of the LLMs in outputting high quality plans data, but the disclosure is not limited thereto. For example, the automated data processing and generation module disclosed herein with reference to FIGS. 1-5 may be configured to automatically generate travel plans data by gathering and combining travel information from LLM and other sources, and then computing a valid travel itinerary using an automated planner that guarantees the solution coherence and quality. The execution of this itinerary may also be monitored by the automated data processing and generation module in order to generate high quality data that suggests opportunities and replan in the event the computed plan data may not be carried out in a real world scenario.

Although the invention has been described with reference to several exemplary embodiments, it is understood that the words that have been used may be words of description and illustration, rather than words of limitation. Changes may be made within the purview of the appended claims, as presently stated and as amended, without departing from the scope and spirit of the present disclosure in its aspects. Although the invention has been described with reference to particular means, materials and embodiments, the invention is not intended to be limited to the particulars disclosed; rather the invention extends to all functionally equivalent structures, method, and uses such as are within the scope of the appended claims.

In some embodiments, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that may be capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium may include a solid-state memory such as a memory card or other package that houses one or more non-volatile read-only memories. Further, the computer-readable medium may be a random access memory or other volatile re-writable memory. Additionally, the computer-readable medium may include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, may be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards may be periodically superseded by faster or more efficient equivalents having essentially the same functions. Accordingly, replacement standards and protocols having the same or similar functions may be considered equivalents thereof.

The illustrations of the embodiments described herein are intended to provide a general understanding of the various embodiments. The illustrations are not intended to serve as a complete description of all of the elements and features of apparatus and systems that utilize the structures or method described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, may be apparent to those of skill in the art upon reviewing the description.

The Abstract of the Disclosure is submitted with the understanding that it may not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A method for improving performance of a data planning system by utilizing one or more processors along with allocated memory, the method comprising:
establishing a communication link among the data planning system, a multimodal large language model, an automated planning device, and a plurality of internal or external systems via a communication interface;
receiving, by the data planning system, user inputs data provided by a user regarding a configurable pre-desired travel plan to a configurable pre-desired travel location;
executing, in response to receiving the user inputs data by the data planning system, an information retrieval process and a planning process to output planning data corresponding to the configurable pre-desired travel plan and the configurable pre-desired travel location by integrating the multimodal large language model and the automated planning device within the data planning system via the communication interface;
wherein the information retrieval process includes:
executing a series of queries to the multimodal large language model and the plurality of internal or external systems, via corresponding application programming interface, that provide data corresponding to the configurable pre-desired location;
generating, in response to executing the series of queries, a plurality of planning tasks data to be utilized by the planning process to output the planning data;
wherein the planning process includes:
executing a series of algorithmic sub-tasks that utilize the plurality of planning tasks data; and
automatically outputting the planning data in response to executing the series of algorithmic sub-tasks, wherein each sub-task utilize information from prior plans to inform computation, thereby improving performance of the data planning system in outputting the planning data and displaying the planning data onto a user interface within the data planning system.

2. The method of claim 1, wherein in executing the series of queries to the multimodal large language model, the method further comprising:
(i) requesting for a set of candidate point of interests (POIs) for an input city or region corresponding to the configurable pre-desired travel location;
(ii) for each provided POI in (i), querying for a score that indicates a general popularity of the POIs; and
(iii) for each provided POI in (i), querying for a time a user is recommended to spend in an activity.

3. The method of claim 2, wherein in executing the series of queries to the plurality of internal or external systems, the method further comprising:
querying a map-service API to collect information data corresponding to the configurable pre-desired travel location to populate a travel-time graph; and
collecting, for each pair of POIs among the set of candidate POIs, an estimated time to move from one place to another place within the travel-time graph.

4. The method of claim 3, further comprising:
querying a place information service to obtain a schedule data with opening or closing hours for each POIs and an estimated cost per person.

5. The method of claim 3, further comprising:
querying an internal or external database to collect travel recommendation preference data.

6. The method of claim 3, further comprising:
querying an internal or an external data source for past solutions similar to plans corresponding to the configurable pre-desired travel plan.

7. The method of claim 2, wherein in executing the series of algorithmic sub-tasks, the method further comprising:
(i) executing a trip segregation sub-task that includes, for the set of candidate POIs, geographically clustering using a clustering algorithm that considers one cluster of POIs per each day in the trip;
(ii) executing a task generation sub-task that includes, for each cluster of POIs and associated planning tasks data for each cluster of POIs retrieved by the information retrieval process, translating each piece of information into a state variable represented into a planning domain description language (PDDL);
(iii) executing a task resolution sub-task that includes, outputting the planning data using the PDDL generated in (ii), as well as preferences and constraints defined by the user by utilizing the automated planning device and outputting a sequence of actions that maximizes the score for a given day;
iv) executing a plan composition sub-task that includes, aggregating in a two-level solution that includes: a list of days, with a city and location for a recommended accommodation requested by the user; and a day plan for each day, that includes a suggested schedule for visiting the POIs, eating in restaurants, and moving from one place to another place; and
v) executing a plan monitoring sub-task that includes monitoring execution of the planning data output from the data planning system and outputting a replan data in an event the planning data output from the data planning system cannot be carried out in a real world scenario.

8. The method according to claim 1, wherein a format of the planning data output from the data planning system includes one or more of the following: plain text, comma separated vectors, JavaScript Object Notation (JSON) objects, and executable python code.

9. The method according to claim 1, wherein the user inputs data includes one or more of the following data: number of travelers; city, region, or country to visit; total budget; time span in days; and user preferences on food, places, flight, hotel, and service provider.

10. A system for improving performance of a data planning system, the system comprising:
a processor; and
a memory operatively connected to the processor via a communication interface, the memory storing computer readable instructions, when executed, causes the processor to:
establish a communication link among the data planning system, a multimodal large language model, an automated planning device, and a plurality of internal or external systems via a communication interface;
receive, by the data planning system, user inputs data provided by a user regarding a configurable pre-desired travel plan to a configurable pre-desired travel location;
execute, in response to receiving the user inputs data by the data planning system, an information retrieval process and a planning process to output planning data corresponding to the configurable pre-desired travel plan and the configurable pre-desired travel location by integrating the multimodal large language model and the automated planning device within the data planning system via the communication interface;
wherein in executing the information retrieval process, the processor is further configured to:
execute a series of queries to the multimodal large language model and the plurality of internal or external systems, via corresponding application programming interface, that provide data corresponding to the configurable pre-desired location;
generate, in response to executing the series of queries, a plurality of planning tasks data to be utilized by the planning process to output the planning data;
wherein in executing the planning process, the processor is further configured to:
execute a series of algorithmic sub-tasks that utilize the plurality of planning tasks data; and
automatically output the planning data in response to executing the series of algorithmic sub-tasks, wherein each sub-task utilize information from prior plans to inform computation, thereby improving performance of the data planning system in outputting the planning data and displaying the planning data onto a user interface within the data planning system.

11. The system of claim 10, wherein in executing the series of queries to the multimodal large language model, the processor is further configured to:
(i) request for a set of candidate point of interests (POIs) for an input city or region corresponding to the configurable pre-desired travel location;
(ii) for each provided POI in (i), query for a score that indicates a general popularity of the POIs; and
(iii) for each provided POI in (i), query for a time a user is recommended to spend in an activity.

12. The system of claim 11, wherein in executing the series of queries to the plurality of internal or external systems, the processor is further configured to:
query a map-service API to collect information data corresponding to the configurable pre-desired travel location to populate a travel-time graph; and
collect, for each pair of POIs among the set of candidate POIs, an estimated time to move from one place to another place within the travel-time graph.

13. The system of claim 12, wherein the processor is further configured to:
query a place information service to obtain a schedule data with opening or closing hours for each POIs and an estimated cost per person.

14. The system of claim 12, wherein the processor is further configured to:
query an internal or an external database to collect travel recommendation preference data.

15. The system of claim 12, wherein the processor is further configured to:
query an internal or external data source for past solutions similar to plans corresponding to the configurable pre-desired travel plan.

16. The system of claim 11, wherein in executing the series of algorithmic sub-tasks, the processor is further configured to:
(i) execute a trip segregation sub-task that includes, for the set of candidate POIs, geographically clustering using a clustering algorithm that considers one cluster of POIs per each day in the trip;
(ii) execute a task generation sub-task that includes, for each cluster of POIs and associated planning tasks data for each cluster of POIs retrieved by the information retrieval process, translating each piece of information into a state variable represented into a planning domain description language (PDDL);
(iii) execute a task resolution sub-task that includes, outputting the planning data using the PDDL generated in (ii), as well as preferences and constraints defined by the user by utilizing the automated planning device and outputting a sequence of actions that maximizes the score for a given day;
iv) execute a plan composition sub-task that includes, aggregating in a two-level solution that includes: a list of days, with a city and location for a recommended accommodation requested by the user; and a day plan for each day, that includes a suggested schedule for visiting the POIs, eating in restaurants, and moving from one place to another place; and
v) execute a plan monitoring sub-task that includes monitoring execution of the planning data output from the data planning system and outputting a replan data in an event the planning data output from the data planning system cannot be carried out in a real world scenario.

17. The system according to claim 10, wherein a format of the planning data output from the data planning system includes one or more of the following: plain text, comma separated vectors, JavaScript Object Notation (JSON) objects, and executable python code.

18. The system according to claim 10, wherein the user inputs data includes one or more of the following data: number of travelers; city, region, or country to visit; total budget; time span in days; and user preferences on food, places, flight, hotel, and service provider.

19. A non-transitory computer readable medium configured to store instructions for improving performance of a data planning system, the instructions, when executed, cause a processor to perform the following:
establishing a communication link among the data planning system, a multimodal large language model, an automated planning device, and a plurality of internal or external systems via a communication interface;
receiving, by the data planning system, user inputs data provided by a user regarding a configurable pre-desired travel plan to a configurable pre-desired travel location;
executing, in response to receiving the user inputs data by the data planning system, an information retrieval process and a planning process to output planning data corresponding to the configurable pre-desired travel plan and the configurable pre-desired travel location by integrating the multimodal large language model and the automated planning device within the data planning system via the communication interface;
wherein the information retrieval process includes:
executing a series of queries to the multimodal large language model and the plurality of internal or external systems, via corresponding application programming interface, that provide data corresponding to the configurable pre-desired location;
generating, in response to executing the series of queries, a plurality of planning tasks data to be utilized by the planning process to output the planning data;
wherein the planning process includes:
executing a series of algorithmic sub-tasks that utilize the plurality of planning tasks data; and
automatically outputting the planning data in response to executing the series of algorithmic sub-tasks, wherein each sub-task utilize information from prior plans to inform computation, thereby improving performance of the data planning system in outputting the planning data and displaying the planning data onto a user interface within the data planning system.

20. The non-transitory computer readable medium of claim 19, wherein in executing the series of queries to the multimodal large language model, the instructions, when executed, cause the processor to further perform the following:
(i) requesting for a set of candidate point of interests (POIs) for an input city or region corresponding to the configurable pre-desired travel location;
(ii) for each provided POI in (i), querying for a score that indicates a general popularity of the POIs; and
(iii) for each provided POI in (i), querying for a time a user is recommended to spend in an activity.
